(19) United States
(12) Patent Application Publication
(10) Pub. No.: US 2026/0117542 A1
(43) Pub. Date: Apr. 30, 2026

(54) LIVING MODULE WHICH CAN BE DEPLOYED FROM A CONTAINER

(71) Applicant: UTILIS SA, Ennery (FR)

(72) Inventor: Philippe PREVOST, Metz (FR)

(73) Assignee: UTILIS SA, Ennery (FR)

(21) Appl. No.: 18/856,525

(22) PCT Filed: Apr. 6, 2023
(86) PCT No.: PCT/IB2023/053536

§ 371 Date: Oct. 24, 2024

(30) Foreign Application Priority Data
Apr. 11, 2022 (FR) FR2203311

(51) Int. Cl. E04H 1/12; E04B 1/343; E04B 1/344

(52) U.S. Cl. CPC E04H 1/12; E04B 1/34336; E04B 1/3444; E04B 1/3445

(57) ABSTRACT

A deployable living module includes a container, having a floor and at least one lateral opening, a deployable floor, and a tent carrier structure including a plurality of arches, the deployable floor being mobile between a folded position and a deployed position. The tent carrier structure is mobile between a folded position in which the arches are close to each other, and the tent carrier structure is placed inside the container, and a deployed position in which the arches are spaced apart from each other, and the tent carrier structure extends outside the container, and rests on parts of the floor of the container and the deployable floor.

### TECHNICAL FIELD OF THE INVENTION

The present invention concerns the field of housing modules which are transportable, in a folded configuration, in a container, and which can be deployed from this container.

### Prior Art

Many examples of living modules that can be transported in containers are known, which most often have standardized dimensions to facilitate their transport, and which can be deployed from this container. Such living modules are commonly used by armed forces deployed on operations, for which they can be used as accommodation, as an office, as a living space, as a field hospital, etc.

In their folded configuration, these containers have the same shapes and the same dimensions as standard containers. They can therefore be easily transported by the usual modes of transport of the containers.

When placed at their place of use, such containers can be opened and deployed in order to establish a habitable, enclosed and covered space, larger than the volume of the container itself. For this, the container commonly comprises mobile walls, partition, roof or floor elements that are mobile relative to the structure of the container. These elements can be contained in the container in the folded position thereof or deployed from the container, outside the initial volume thereof, in the deployed position.

The containers can also comprise structural elements capable of carrying tents. These tent carrier structural elements and the tents are also mobile between a position in which they are contained in the container and a position in which they are deployed outside the container.

Most often, all the elements needed for assembly of the mobile housing are contained in the same container.

Many examples of such deployable containers, with varied deployment kinematics, are known. In some cases, the deployment of the housing from the container can be done very easily, for example by sliding a lateral wall of the container outwards, in order to enlarge the inner volume of the housing. Such solutions, which are very easy to implement, however, most often only offer a relatively restricted habitable volume.

Other solutions are also known in which a container can contain structures capable of carrying tents, which can extend over a relatively large surface to provide a larger habitable volume. The deployment of such housing modules, however, requires numerous assembly steps, which may require the use of components that cannot be contained in a single container.

### Objectives of the Invention

The present invention aims to provide a living module, transportable in a container and deployable from this container, which can be deployed particularly easily and quickly.

Another objective of the invention is to offer such a living module which offers, in its deployed configuration, a particularly large habitable volume, in proportion to the initial volume of the container.

### Disclosure of the Invention

These objectives, as well as others which will appear more clearly later, are achieved using a deployable living module comprising:
a container having a floor and at least one lateral opening,
at least one deployable floor, composed of at least one floor panel, and
at least one tent carrier structure comprising a plurality of arches extending in planes substantially parallel to each other,
   the deployable floor being connected to the container, and mobile between:
a folded position in which the floor panels extend substantially vertically inside the container,
a deployed position in which the floor panels extend horizontally outside the container, in front of the lateral opening, in line with the floor of the container.

According to the invention, the tent carrier structure is mobile between:
a folded position in which the arches of the tent carrier structure extend in planes substantially parallel to each other, relatively close to each other, and in which the entirety of the tent carrier structure is placed inside the container, and
a deployed position in which the arches of the tent carrier structure extend in planes substantially parallel to each other, relatively spaced apart from each other, and in which the tent carrier structure extends both inside and outside the container, through the lateral opening, and rests on at least a part of the floor of the container and on at least a part of the deployable floor which is in its deployed position.

Such a mobile tent carrier structure and deployable floor allow a living module to be quickly created from a container. In addition, the plurality of arches of the tent carrier structure extended over the floor panels allow the living module to cover a relatively large surface.

Preferably, an edge of a first panel of the floor panels is secured to a first branch of at least one carrier bracket, the second branch of which is connected to the container.

These carrier brackets, which are advantageously pivotally mounted and whose first branches are fastened to the floor of the container, make it possible to move the entirety of the deployable floor between its folded position and its deployed position.

Preferably, the floor panels are connected together along their edges.

Preferably, a second panel of the floor panels is connected to the first floor panel, and sized to span, in its deployed position, the space appearing between the floor of the container and the first floor panel in its deployed position.

In this way, when in its deployed position, the second panel of the floor panels constitutes an extension of the floor of the container.

Advantageously, the container has at least one lateral opening capable of allowing the deployment of the deployable floor, and at least one mobile lateral wall capable of closing the lateral opening when the deployable floor is in its folded position.

Advantageously, in their folded position, the panels of the floor are placed in the container between the lateral opening and the arches in their folded position.

Advantageously, the arches comprise a stationary arch, fastened inside the container and a plurality of mobile arches capable, when the floor is in its deployed position, of moving relative to the stationary arch and relative to each other, by transfer in a horizontal direction perpendicular to the plane in which they extend.

Advantageously, the mobile arches comprise sliding means capable of sliding on the floor panels.

Advantageously, the sliding means comprise wheels borne by the lower ends of uprights of the mobile arches.

Advantageously, the floor of the container and the deployable floor panels comprise means for guiding the mobile arches, extending continuously over the floor of the container and the deployable floor panels when the deployable floor panels are in their deployed position.

Advantageously, the guide means comprise at least one rail extending in a direction substantially perpendicular to the plane in which the mobile arches extend.

Preferably, in the folded position of the tent carrier structure, the mobile arches are placed between the lateral opening and the stationary arch.

Advantageously, the living module has two of the lateral openings, on two opposite faces of the container, it comprises one of the deployable floors extending, in its deployed position, in front of each of the lateral openings, and one of the tent carrier structures extending, in its deployed position, through each of the lateral openings.

According to an advantageous embodiment of the invention, the lower surface of the deployable floor has rigid supports capable of supporting it in height.

Such rigid supports may be feet, connected to the lower face of the floor panels. These feet may be telescopic to adapt to the height between the floor and the ground. Furthermore, it is possible for the floor panels to have several rigid supports, such as several feet, of different sizes, so that it is possible to choose the rigid support to be used depending on the installation conditions of the living module.

### LIST OF THE FIGURES

The invention will be better understood on reading the following description of preferred embodiments, given as a simple figurative and non-limiting example, and accompanied by the figures among which:

FIG. 1 is a representation of a living module which can be deployed from a container according to one embodiment of the invention.

FIG. 2 is a representation of the deployable living module of FIG. 1 whose floor is in the deployed position.

FIG. 3 is a representation of the deployable living module of FIG. 2 whose tent carrier structure is partially deployed.

FIG. 4 is a representation of the deployable living module of FIG. 2 whose tent carrier structure is fully deployed.

FIG. 5 is a cross-sectional view of the living module which can be deployed from a container, according to one embodiment, and whose floor and tent carrier structure are in folded positions.

FIG. 6 is a cross-sectional view of the living module of FIG. 5 whose floor is partially deployed.

FIG. 7 is a cross-sectional view of the living module of FIG. 5 whose floor is partially deployed.

FIG. 8 is a cross-sectional view of the living module of FIG. 5 whose floor is fully deployed.

FIG. 9 is a cross-sectional view of the living module of FIG. 8 whose tent carrier structure is partially deployed.

FIG. 10 is a cross-sectional view of the living module of FIG. 8 whose tent carrier structure is fully deployed.

FIG. 11 is a representation of a portion of tent carrier structure that can be implemented in the living module of FIG. 1.

FIG. 12 is a schematic representation of a deployable living module according to one embodiment of the invention, which is carried by a vehicle, and fully deployed from this vehicle.

### DETAILED DESCRIPTION OF EMBODIMENTS OF THE INVENTION

### 1. Overall Composition of the Structure

### a. The Container

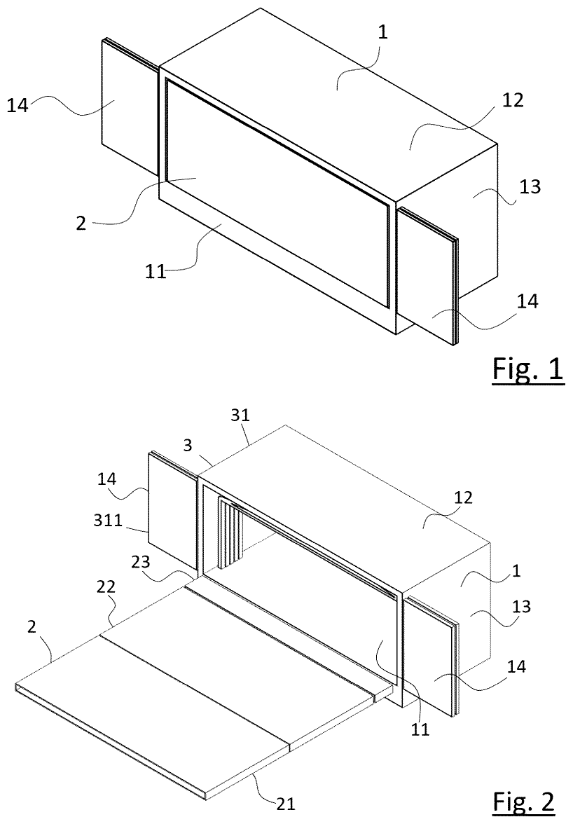

FIG. 1 is a representation of a living module which can be deployed from a container, according to one embodiment of the invention, which is in a folded position. The living module comprises a container 1, a deployable floor 2, and a deployable tent carrier structure 3. In the folded position, represented by FIG. 1, the deployable floor 2 and the tent carrier structure 3 are in the folded position inside the container 1.

The container 1 is composed of a metal structure in the shape of a rectangular parallelepiped which defines an inner space, and which has a floor 11, a roof 12, end lateral walls 13, and mobile lateral walls 14 which make it possible to open and close one of the sides of the container 1. In the configuration represented in FIG. 1, these mobile walls 14 are represented open.

### b. The Contents of the Container

In the configuration represented in FIG. 1, the deployable floor 2 is in a so-called folded position in which the floor panels which compose it extend in a direction vertical and perpendicular to the floor 11 of the container 1.

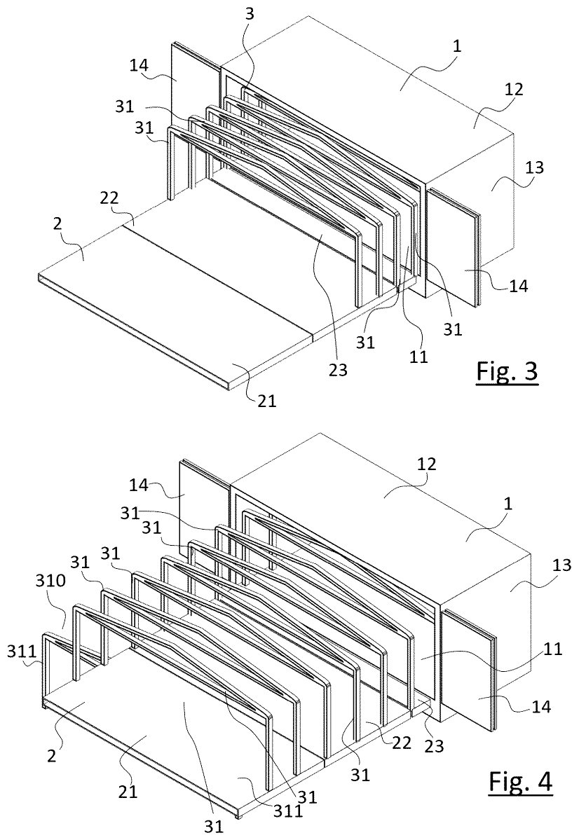

In this folded position, the deployable floor is positioned in the container 1 behind the mobile walls 14 when they are in the closed position. Thus, a deployable floor panel 21 is visible when the mobile walls 14 are open, as shown in FIG. 1. The tent carrier structure 3, in its folded position, is positioned in the container 1 behind the deployable floor 2 in the folded position. Thus, this tent carrier structure 3 in its folded position is visible when the deployable floor 2 is in the deployed position, as shown in FIG. 3.

### 2. Floor

### a. Folded Position

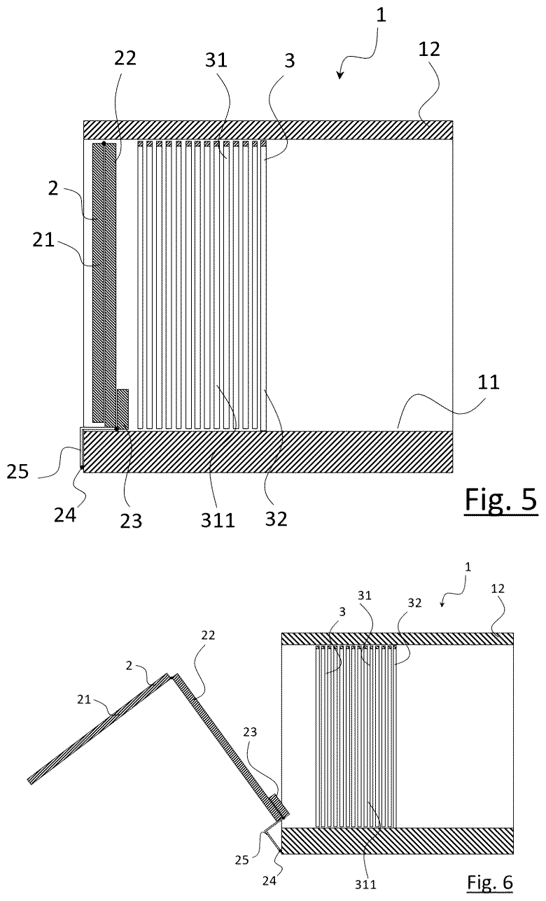

FIG. 5 is a cross-sectional view of the living module in which the deployable floor 2 and the tent carrier structure 3 are in their folded positions in the container 1.

In the represented embodiment, the deployable floor 2 comprises three deployable floor panels 21, 22 and 23 having rectangular shapes. The neighboring deployable floor panels 21 and 22 are connected to each other, at their ends, by connecting means such as hinges 24. In addition, the deployable floor panel 23, of smaller size, is connected to the deployable floor panel 22 by connecting means such as hinges 27.

In the folded position represented in FIG. 5, the surfaces of the deployable floor panels 21, 22 and 23 are superimposed on each other and extend vertically, in a direction perpendicular to the floor 11 of the container 1.

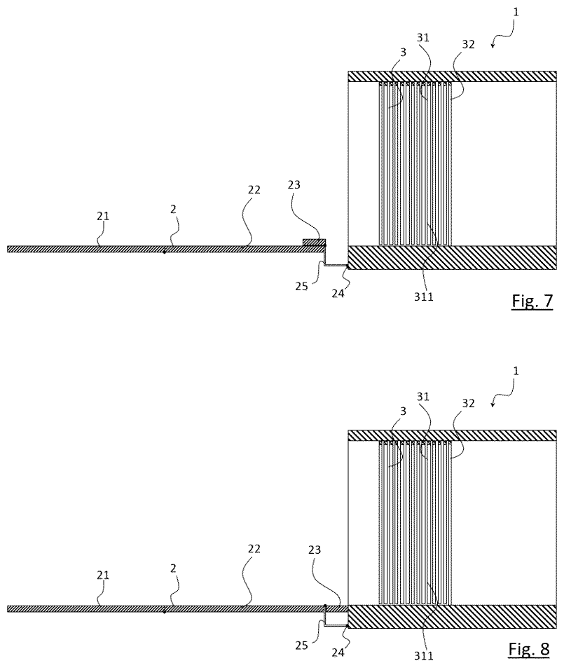

Carrier brackets 25, a first branch of which is secured to an edge of the deployable floor panel 22, are pivotally mounted relative to the container 1 by means of hinges 26 articulating the second branch of each bracket to the edge of the container. These carrier brackets 25 are dimensioned such that their rotation, around the hinge 26, allows the deployable floor panel 22 to be brought into a deployed position, represented by FIG. 7, in which the surface of this deployable floor panel 22 is located in the same plane as the surface of the floor 11 of the container.

Preferably, when they are folded, each carrier bracket 25 fits the rim of the floor 11 of the container 1. Thus, each carrier bracket 25, when the deployable floor 2 is in its folded position, has one of its branches positioned between the deployable floor 2 and the floor of the container 11, while its second branch is positioned on the rim of the floor of the container 11, on the side of the opening of the container 1.

### b. Intermediate Position

FIGS. 6 and 7 are representations of the living module in which the deployable floor 2 is in intermediate positions between its folded and deployed positions.

During a first step of the deployment of the floor 11, the deployable floor panel 21 and the deployable floor panel 22 are simultaneously pivoted, respectively, relative to the deployable floor panel 22, around the hinges 24, and relative to the container 1, around the hinges 26 of the brackets 25. FIG. 6 shows the deployable floor 2 during the execution of this first step.

At the end of this first step, the panels 21 and 22 extend horizontally in the extension of one another, and their surface is in the same plane as the surface of the floor 11 of the container 1, as represented in FIG. 7. The rotation of the brackets 25 has caused an empty space to appear above the brackets 25, between the deployable floor panel 22 and the floor 11 of the container 1. The deployable floor panel 23 remains folded against the deployable floor panel 22.

### c. Deployed Position

During a second step of the deployment of the floor 11, the deployable floor panel 23 is also deployed, by rotation around the hinges 27 in order to fill the empty space created between the deployable floor panel 22 and the floor 11 of the container 1, as represented in FIG. 8. Preferably, the deployable floor panel 23 has dimensions complementary to the dimensions of the empty space created by the brackets 25.

Following deployment of the deployable floor panel 23, the entirety of the deployable floor 2 is deployed in the horizontal direction and, advantageously, the deployable floor 2 constitutes an extension of the upper part of the floor 11 of the container 1.

Thus, the living module has a large floor surface, which comprises the surface of the floor 11 of the container and the surface of the deployable floor 2 which extend in continuity with each other.

FIGS. 2, 3 and 4 represent the living module in configurations in which the deployable floor panel 2 is in its deployed position.

The deployable floor may be designed to be self-supporting in its deployed position, so as to be linked only to the container 1. However, the deployable floor may also be equipped with feet allowing, by resting on the ground, to keep it horizontal. For example, the deployable floor 2 may rest on feet placed under the hinge 24 and under the free edge of the panel 21, opposite the edge bearing the hinge 24.

### d. Variants

The deployment mode of the deployable floor 2 which is represented by FIGS. 5 to 8, is a preferred example which is not limiting of the invention. The person skilled in the art will thus be able to imagine other solutions for a deployable floor connected to the container 1, and mobile between a folded position, in which the floor panels extend substantially vertically inside the container 1, and a deployed position in which the floor panels extend horizontally outside the container, in the extension of the floor of the container.

Among these variants, those in which the deployable floor is composed of several floor panels connected to each other are preferred, insofar as they make it possible to obtain a larger floor surface.

### 3. Tent Carrier Structure 3

### a. Deployment of the Arches

As represented in FIG. 5, when the deployable floor 2 and the tent carrier structure 3 are in folded positions, the tent carrier structure 3 is positioned behind the deployable floor 2.

In this folded position, the tent carrier structure 3 comprises a succession of arches, including a stationary arch 32 and mobile arches 31, which are brought closer to each other and kept parallel. The stationary arch 32 and the mobile arches 31 may advantageously be identical or almost identical, the stationary arch 32 being characterized by the fact that it is fastened inside the container.

The arches 31 and 32 are advantageously linked to each other, such that they can move relative to each other, essentially in a direction perpendicular to the plane in which they are inscribed, while remaining parallel to each other.

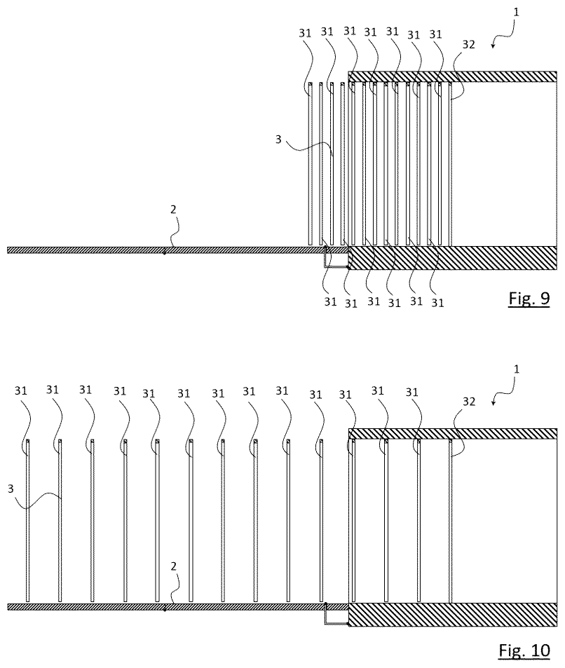

FIG. 8 represents the arches 31 and 32 of the tent carrier structure 3, in their folded configuration and FIG. 10 represents them in their deployed configuration. FIG. 9 represents these arches in an intermediate configuration between the folded and deployed configurations. In FIGS. 1 to 10, the parts connecting the arches 31 and 32 are not represented.

During this deployment, the mobile arches 31 advantageously rest on the surface formed by the floor 11 of the container and the deployable floor 2 in the deployed position.

### b. Structure of the Arches

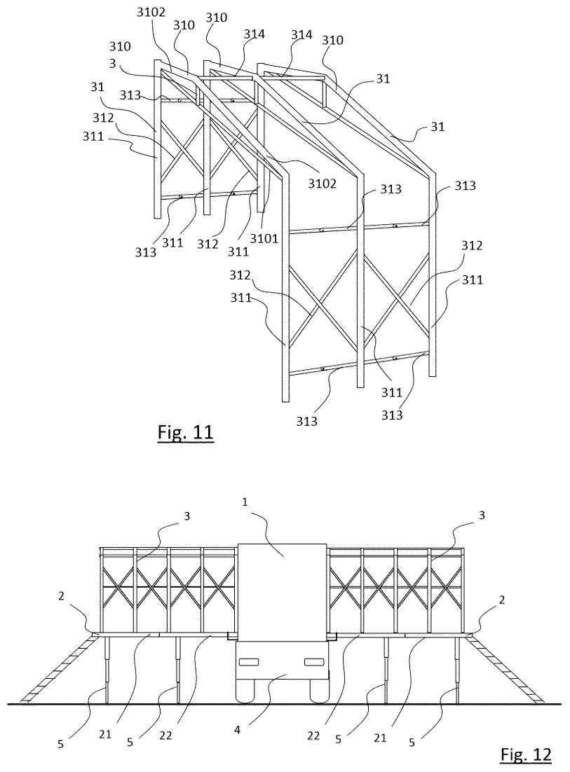

FIG. 11 represents a segment of the tent carrier structure 3, this segment comprising three arches 31 assembled to each other, in a deployed configuration.

According to this embodiment, the tent carrier structure 3 comprises a succession of rigid arches 31 kept parallel to each other. Each of the arches 31 is made of metal tubes assembled together in the same plane. These tubes form a truss 310 mounted on the upper ends of two uprights 311. Each of these trusses 310 is composed of two rafters 3102 connecting a tie beam 3101 to a king post 3103.

### c. Keeping the Arches

Preferably, the arches 31 of the tent carrier structure 3 are kept parallel to each other by compass systems, which may in particular be pantographs 312. In the present description, the pantographs are defined as lattice devices, allowing two neighboring arches to move closer or further apart, while keeping them parallel to each other.

In the represented embodiment, these pantographs 312 are composed of two lattices forming an “X” connected in their middle, the lower end of each lattice being pivotally mounted on the upright 311 of one of the arches 31, and the upper end being slidably mounted in the upright 311 of the opposite arch 31 thanks to a sliding pivot sliding in a groove extending along this upright. This device makes it possible to ensure variable spacing between the arches while keeping them parallel to each other.

Advantageously, the upper ends of two lattices slidably mounted on a single upright are connected to each other to slide together. Thus, the pantographs can be dependent on each other and deploy together, the pantographs can ensure that all arches of the same tent carrier structure are spaced from each other evenly.

It is also possible for the upper ends of two lattices to slide independently on the same upright. In such a case, it is possible to move some arches apart from each other while keeping other arches close to each other.

According to another possible embodiment, the sliding axes and the stationary axes are respectively positioned at the lower and upper levels of the uprights of the arches.

### Locking Compass 313

The arches 31 are also linked to each other by locking compasses 313 each formed by two connecting rods connected between them and on two neighboring arches 31. These compasses make it possible to limit the spacing in two successive arches to a maximum value. Furthermore, they can be locked by means known to those skilled in the art to keep this spacing at the maximum value corresponding to the deployed position of the tent carrier structure 3.

In this locked configuration, the locking compasses 313 are oriented in a direction substantially parallel to the deployable floor 2 of the container 1.

When the tent carrier structure 3 moves from its deployed position to its folded position, the locking compasses 313 need to be unlocked. In this unlocked configuration, the two rods of the compass fold vertically against the uprights 311 of the arches 31 which bear them.

One of these compasses can form a ridge compass 314 extending between the upper ends of the trusses 310 of two neighboring arches 31. When this compass is deployed, it forms a ridge capable of participating in the carrying of the tent canvas.

### d. Tent

This tent carrier structure 3 is intended to support a tent canvas. In certain embodiments, the tent can be directly associated with the tent carrier structure 3 when the latter is in its folded configuration, and be deployed simultaneously with the deployment of this tent carrier structure 3. In other embodiments, the tent can be installed after the deployment of the tent carrier structure 3.

### e. Arches Equipped With Wheels

In order to facilitate the deployment of the tent carrier structure 3 on the floor 11 of the container 1 and on the deployable floor 2, the arches 31 can be mounted on wheels assembled to the lower ends of the uprights 311 of the arches 31. Preferably, these wheels are oriented so as to facilitate the deployment of the arches 31 on the floor, in a horizontal direction perpendicular to the plane of the arches 31.

Particularly advantageously, the floor may have means for guiding these wheels, making it possible to guide them so that they remain on the deployable floor 2. These guide means may for example consist of grooves or rails, extending parallel to the lateral edges of the deployable floor 2 and capable of guiding the wheels.

Preferably, when the deployable floor 2 is deployed, these guide means extend continuously on the floor 11 of the container 1 and on the floor panels 21, 22 and 23, from the stationary arch 32 to the end of the deployable floor 2 furthest from the container 1.

### f. Two Double-Sided Folding Tents

In the represented embodiments, the container 1 has a lateral opening on one of its lateral faces and comprises a deployable floor on the corresponding side and a deployable tent carrier structure on this deployable floor.

According to other embodiments, it is also possible for the container 1 to have two lateral openings on two opposite faces and to comprise a deployable floor on each of the corresponding sides, as well as a deployable tent carrier structure on each of these deployable floors. The living module thus comprises two tent carrier structures oriented in opposite directions, and capable of being deployed or folded in the same direction.

In this case, each of these tent carrier structures has a structural element fastened inside the living module.

The tents formed by each of the tent carrier structures can interconnect in order to form a large-surface living module.

### g. Module Deployed From a Vehicle

The container containing the living module according to the invention advantageously has the standardized dimensions of the containers, so that it can be easily transported by any means of transport. According to a particularly advantageous embodiment, it is also possible to deploy the living module contained in such a container even while this container is borne by a vehicle.

FIG. 12 is a schematic representation of a living module deployed from a container 1 borne by a vehicle 4, in this case a truck, which is represented seen from behind.

In this embodiment, two deployable floors 2 are deployed from the container 1, each from one of the sides of this container, and each of these deployable floors bears a tent carrier structure 3 deployed from this container.

To be kept in their deployed position, the deployable floors 2 are carried by rigid supports, such as telescopic feet 5, linked to their lower surfaces. For example, these telescopic feet 5 can be positioned at each deployable floor panel 21 and 22.

Advantageously, these telescopic feet can be connected to the lower faces of the floor panels in order to be integrated into the thickness of these floor panels, in a storage position, and to extend perpendicular to these floor panels, in a deployed position. They can advantageously have a variable length, in order to adapt to the height to which the container is borne. Furthermore, the lower faces of the floor panels can be equipped with several sets of rigid supports, such as telescopic feet, capable of taking different heights. Thus, in addition to the telescopic feet 5, provided to keep the floor panels when the container 1 is borne to a significant height, for example on a truck, the floor panels can be equipped with feet of lower height, which can also be telescopic or of adjustable height, the height of which is adapted to keep the floor when the container is placed on the ground, or on low carriers such as concrete blocks. The most suitable feet are then deployed depending on the installation conditions of the container 1.

1. A deployable living module comprising:
a container having a floor and at least one lateral opening,
at least one deployable floor, composed of at least one floor panel, and
at least one tent carrier structure comprising a plurality of arches extending in planes substantially parallel to each other,
said deployable floor being connected to said container, and mobile between:
a folded position in which the floor panels extend substantially vertically inside said container,
a deployed position in which the floor panels extend horizontally outside said container, in front of said lateral opening, in the extension of said floor of the container,
wherein said tent carrier structure is mobile between:
a folded position in which the arches, of said tent carrier structure extend in planes substantially parallel to each other, relatively close to each other, and in which the entirety of said tent carrier structure is placed inside said container, and
a deployed position in which the arches, of said tent carrier structure extend in planes substantially parallel to each other, relatively spaced apart from each other, and in which said tent carrier structure extends both inside and outside said container, through said lateral opening, and rests on at least a part of said floor of said container and on at least a part of said deployable floor which is in its deployed position.

2. The deployable living module according to claim 1, wherein an edge of a first panel of said floor panels, is secured to a first branch of at least one carrier bracket, a second branch of which is connected to said container.

3. The deployable living module according to claim 1, wherein said floor panels are connected together along their edges.

4. The deployable living module according to claim 1, wherein it comprises a second panel of said floor panels, connected relative to said first floor panel, sized to span, in its deployed position, the space appearing between said floor of said container and said first floor panel in its deployed position.

5. The deployable living module according to claim 1, wherein said container has at least one lateral opening capable of allowing the deployment of said deployable floor, and at least one mobile lateral wall capable of closing said lateral opening when said deployable floor is in its folded position.

6. The deployable living module according to claim 1, wherein, in their folded position, said floor panels are placed in said container between said lateral opening and said arches in their folded position.

7. The deployable living module according to claim 1, wherein said arches comprise a stationary arch, fastened inside the container and a plurality of mobile arches capable, when said deployable floor is in its deployed position, of moving relative to said stationary arch and relative to each other, by transfer in a horizontal direction perpendicular to the plane in which they extend.

8. The deployable living module according to claim 1, wherein said mobile arches comprise sliding means capable of sliding on said floor panels.

9. The deployable living module according to claim 1, wherein said sliding means comprise wheels borne by the lower ends of uprights of said mobile arches.

10. The deployable living module according to claim 8, wherein said floor of said container and said deployable floor panels comprise means for guiding said mobile arches, extending continuously on said floor of said container and said deployable floor panels when said deployable floor panels are in their deployed position.

11. The deployable living module according to claim 1, wherein said guide means comprise at least one rail extending in a direction substantially perpendicular to the plane in which said mobile arches extend.

12. The deployable living module according to claim 7, wherein, in said folded position of said tent carrier structure, said mobile arches are placed between said lateral opening and said stationary arch.

13. The deployable living module according to claim 1, wherein it has two of said lateral openings, on two opposite faces of said container, and in that it comprises one of said deployable floors extending, in its deployed position, in front of each of said lateral openings, and one of said tent carrier structures extending, in its deployed position, through each of said lateral openings.

14. The deployable living module according to claim 1, wherein the lower surface of the deployable floor has rigid supports capable of supporting it in height.

15. The deployable living module according to claim 2, wherein said floor panels are connected together along their edges.

16. The deployable living module according to claim 2, wherein said container has at least one lateral opening capable of allowing the deployment of said deployable floor, and at least one mobile lateral wall capable of closing said lateral opening when said deployable floor is in its folded position.

17. The deployable living module according to claim 3, wherein said container has at least one lateral opening capable of allowing the deployment of said deployable floor, and at least one mobile lateral wall capable of closing said lateral opening when said deployable floor is in its folded position.

18. The deployable living module according to claim 4, wherein said container has at least one lateral opening capable of allowing the deployment of said deployable floor, and at least one mobile lateral wall capable of closing said lateral opening when said deployable floor is in its folded position.

19. The deployable living module according to claim 2, wherein said arches comprise a stationary arch, fastened inside the container and a plurality of mobile arches capable, when said deployable floor is in its deployed position, of moving relative to said stationary arch and relative to each other, by transfer in a horizontal direction perpendicular to the plane in which they extend.

20. The deployable living module according to claim 3, wherein said arches comprise a stationary arch, fastened inside the container and a plurality of mobile arches capable, when said deployable floor is in its deployed position, of moving relative to said stationary arch and relative to each other, by transfer in a horizontal direction perpendicular to the plane in which they extend.
